(19) United States
(12) Patent Application Publication
(10) Pub. No.: US 2006/0077301 A1
(43) Pub. Date: Apr. 13, 2006

(54) Secam color difference signal processing method

(75) Inventor: Yasuhiko Okamoto, Tokyo (JP)

Correspondence Address: NIXON PEABODY, LLP, 401 9TH STREET, NW, SUITE 900, WASHINGTON, DC, 20004-2128, US

(73) Assignee: Oki Electric Industry Co., Ltd.

(21) Appl. No.: 11/222,760

(22) Filed: Sep. 12, 2005

(30) Foreign Application Priority Data
Sep. 30, 2004 (JP) 2004-288903

(51) Int. Cl. H04N 9/66

(52) U.S. Cl. 348/638

(57) ABSTRACT

A SECAM video signal is decoded by selecting different combinations of chrominance signals according to the luminance difference between the current line and the preceding line. The chrominance signals from the current line and the preceding line are selected when this difference is smaller than a threshold. The chrominance signals from the current line and the next line are selected when the difference is greater than the threshold. The average value of the chrominance signals in the preceding and following lines may be calculated and selected in place of the chrominance signal from the preceding line.

### BACKGROUND OF THE INVENTION

1. Field of the Invention

The present invention relates to SECAM video signal processing, more particularly to color difference signal processing in, for example, a SECAM digital video decoder.

2. Description of the Related Art

SECAM (Sequential Coleur avec Memoire) is a standard video signal format used in France and various countries in Africa, Eastern Europe, the Mideast, and the Pacific. Unlike the NTSC (National Television Systems Committee) and PAL (Phase Alternation Line) signal formats used elsewhere, the SECAM format encodes different color signals in alternate raster lines. A device such as a digital video decoder that processes a SECAM signal customarily processes the color components of the current line and the preceding line together to obtain the complete color information for the current line.

More specifically, the SECAM format encodes the red color difference signal and blue color difference in alternate lines. As there are an odd number of lines per frame, a line encoding blue color information in one frame encodes red color information in the next frame, and vice versa. A consequent problem is that when a video image includes a predominantly red line preceded by a predominantly blue line, frames in which this line has a strong combined color signal alternate with frames in which the line has a weak or absent color signal, causing the line to flicker at half the frame rate. A similar type of flicker occurs when there are other abrupt vertical changes in color.

It would be desirable if a SECAM signal could be processed to eliminate or reduce this type of flicker.

### SUMMARY OF THE INVENTION

An object of the present invention is to process a SECAM video signal so as to reduce color flicker.

Another object is to process a SECAM video signal so as to reduce spatial color noise.

In the invented method of processing a SECAM video signal, the signal is demodulated and delayed to obtain a first luminance signal, a second luminance signal lagging the first luminance signal by one horizontal interval, a first chrominance signal, a second chrominance signal lagging the first chrominance signal by one horizontal interval, and a third chrominance signal lagging the second chrominance signal by one horizontal interval. The difference between the first and second luminance signals is calculated, and different combinations of the first, second, and third chrominance signals are selected according to the difference.

In one embodiment, the second and third chrominance signals, representing color difference data from the current line and the preceding line, are selected when the luminance difference is less than a predetermined threshold. When the luminance difference is greater than the predetermined threshold, the first and second chrominance signals, representing color difference data from the current line and the next line, are selected.

In another embodiment, the first and third chrominance signals are averaged and the average value is selected in place of the third chrominance signal when the luminance difference is less than the threshold.

In both embodiments, flicker is reduced by avoiding combining color information from the preceding line with color information from the current line when a large luminance difference indicates a probable large color change between these two lines.

Use of the average value helps to reduce spatial color noise.

### BRIEF DESCRIPTION OF THE DRAWINGS

In the attached drawings:

FIG. 1 is a block diagram showing the general structure of a digital video decoder;

FIG. 2 is a block diagram showing the structure of a color difference data processing circuit according to a first embodiment of the invention;

FIG. 3 is a block diagram showing the structure of a color difference data processing circuit according to a second embodiment;

FIG. 4 is a schematic block diagram showing the structure of a conventional color difference data processing circuit;

FIGS. 5 and 6 are block diagrams showing examples of conventional color difference data processing;

FIG. 7 is a table illustrating the input format of SECAM video data line by line and field by field;

FIG. 8 is a table illustrating the conventional output format SECAM video data line by line and field by field;

FIG. 9 is a table illustrating the SECAM input data in FIG. 7 for a still image with a blue upper part and a red lower part;

FIG. 10 is a table illustrating conventional processing of the data in FIG. 9;

FIG. 11 is a table illustrating processing of the data in FIG. 9 in the first embodiment of the invention; and

FIG. 12 is a block diagram showing the structure of a color difference data processing circuit according to a variation of the second embodiment of the invention.

### DETAILED DESCRIPTION OF THE INVENTION

Two embodiments of the invention will now be described with reference to the attached drawings, in which like elements are indicated by like reference characters.

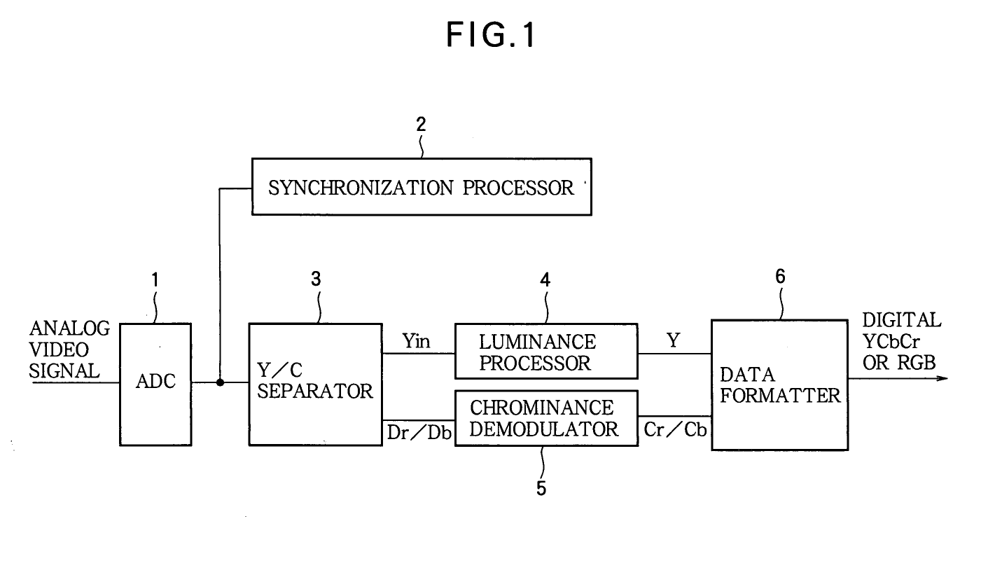

Both embodiments are useful in, for example, a digital video decoder of the type shown in FIG. 1, which receives an analog SECAM video signal and outputs a digital color video signal. The SECAM signal is received by an analog-to-digital converter (ADC) 1 and converted to a digital signal. A synchronization processor 2 extracts horizontal and vertical synchronizing components from the digital signal. A luminance/chrominance (Y/C) separator 3 separates the frequency-modulated chrominance component (Dr/Db) of the digital signal from the amplitude-modulated luminance component (Yin). The notation Dr/Db indicates that the chrominance signal switches between red color difference information and blue color difference information in alternate lines. A luminance processor 4 processes the separated luminance signal Yin by amplifying it and removing the horizontal synchronizing component to obtain a luminance data signal Y. A chrominance demodulator 5 processes the separated chrominance signal Dr/Db to obtain a pair of color difference data signals Cr and Cb. A data formatter 6 processes the luminance and color difference data to generate digital video output signals. The output may be in either the luminance/color-difference format (YCbCr) or red-green-blue format (RGB).

### First Embodiment

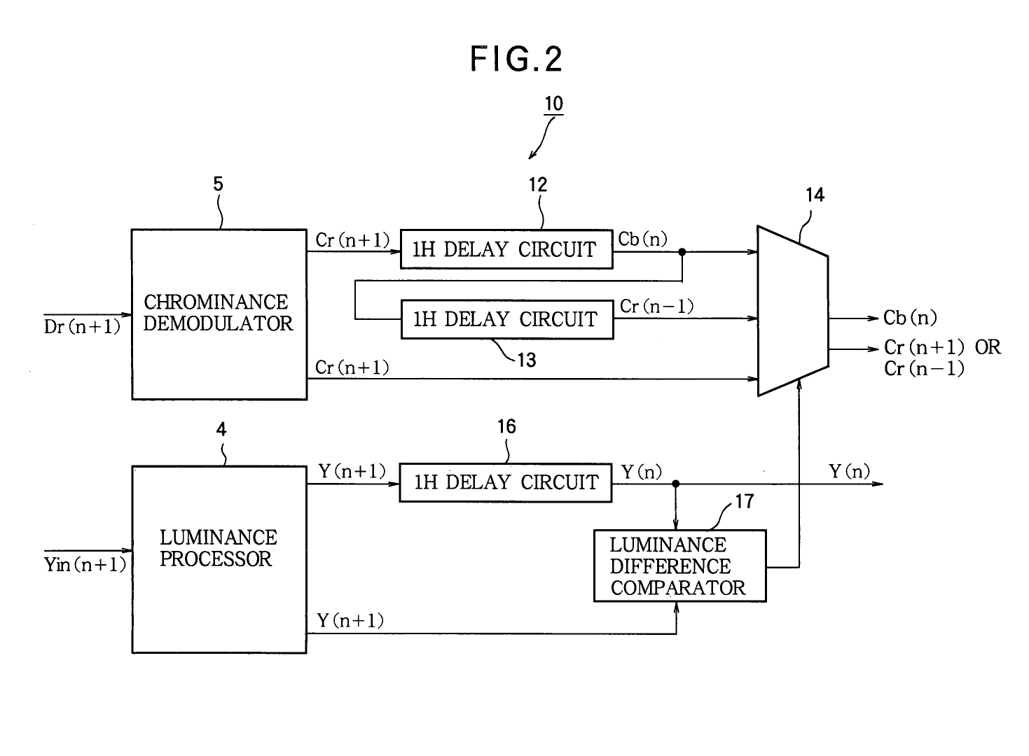

FIG. 2 shows a SECAM signal data processing circuit 10 that includes the luminance processor 4, the chrominance demodulator 5, and part of the data formatter 6 in FIG. 1 in a first embodiment of the invention. The part of the data processing circuit 10 disposed in the data formatter includes a cascaded pair of 1H delay circuits 12, 13, a selector 14, another 1H delay circuit 16, and a luminance difference comparator 17. This circuit 10 outputs luminance and color difference data for a given line n while receiving the digitized SECAM signal for the next line (n+1).

The chrominance demodulator 5 demodulates the separated chrominance signal to obtain color difference data. As an example, the chrominance demodulator 5 is shown as receiving a chrominance signal Dr(n+1) for line (n+1) when the chrominance signal for this line encodes red color difference information. The color difference data signal output from the chrominance demodulator 5 is accordingly denoted Cr(n+1).

The color difference data signal output from the chrominance demodulator 5 is delayed by the cascaded pair of 1H delay circuits 12, 13, each of which delays the signal by one horizontal interval (1H), that is, by one raster line. The delayed signal output from the first 1H delay circuit 12 represents color difference data from line n, which in this example are blue color difference data Cb(n). The delayed signal output from the second 1H delay circuit 13 represents color difference data from line (n−1), which in this example are red color difference data Cr(n−1).

The selector 14 receives the three color data signals output from the chrominance demodulator 5 and the 1H delay circuits 12, 13, selects two of them, and outputs the two selected signals as a red color difference signal and a blue color difference signal for line n. One of the selected signals is the 1H-delayed output of the first 1H delay circuit 12 (Cb(n) in the drawing). The other selected signal is either the undelayed output of the chrominance demodulator 5 (Cr(n+1) in the drawing) or the 2H-delayed output of the second 1H delay circuit 13 (Cr(n−1) in the drawing).

The luminance processor 4 processes the separated luminance signal Yin(n+1) to obtain an amplified luminance signal Y(n+1) without a horizontal synchronizing component. This luminance signal is supplied to the third 1H delay circuit 16, which delays it by one horizontal interval to obtain the luminance signal Y(n) for line n. The luminance signals for both lines n and (n+1) are supplied to the luminance difference comparator 17, which generates a control signal that controls the selector 14 during reception of the next line (n+2), while the selector 14 is selecting color difference data for line (n+1). More specifically, the luminance difference comparator 17 compares the difference between the two luminance signals |Y(n+1)−Y(n)| with a threshold (Th). If the difference is less than the threshold, then in the next line, the luminance difference comparator 17 sets the control signal to a value that causes the selector 14 to select the outputs of the 1H delay circuits 12, 13. If the difference is greater than the threshold, then in the next line, the luminance difference comparator 17 sets the control signal to a value that causes the selector 14 to select the outputs of the chrominance demodulator 5 and 1H delay circuit 13.

In terms of line n, accordingly, the selector 14 selects the color difference signals received in that line (n) and the preceding line (n−1) if the luminance change between that line (n) and the preceding line (n−1) is smaller than the threshold, and selects the color difference signals received in that line (n) and the next line (n+1) if the luminance change between that line (n) and the preceding line (n−1) is greater than the threshold. The selection operation can be summarized as follows, where C(n), C(n−1), and C(n+1) represent the color difference data received in lines n, (n−1), and (n+1), respectively.
If |Y(n)−Y(n−1)|<Th, then select C(n) and C(n−1)
If |Y(n)−Y(n−1)|>Th, then select C(n) and C(n+1)

In the drawing, for example, if the difference between Y(n) and Y(n−1) is less than the threshold (Th), as determined previously by the luminance difference comparator 17 during the input of data from line n, the selector 14 selects Cr(n−1) and Cb(n) as the color difference data for line n. If the difference between Y(n) and Y(n−1) exceeds the threshold, the selector 14 selects Cr(n+1) and Cb(n) as the color difference data for line n.

The luminance difference comparator 17 may operate as described above on the individual picture element (pixel) data. Alternatively, the luminance difference comparator 17 may compare the sum of all the pixel data in line (n+1) with the sum of all the pixel data in line n and generate a control signal with a single value that is valid for the entire next line. Other schemes are also possible: for example, the luminance difference comparator 17 may compare sums of m consecutive pixel values, where m is an integer greater than one but less than the number of pixels per line.

The output of the data processing circuit 10 includes the selected color difference signals and the corresponding luminance signal Y(n), which is obtained from 1H delay circuit 16.

### Second Embodiment

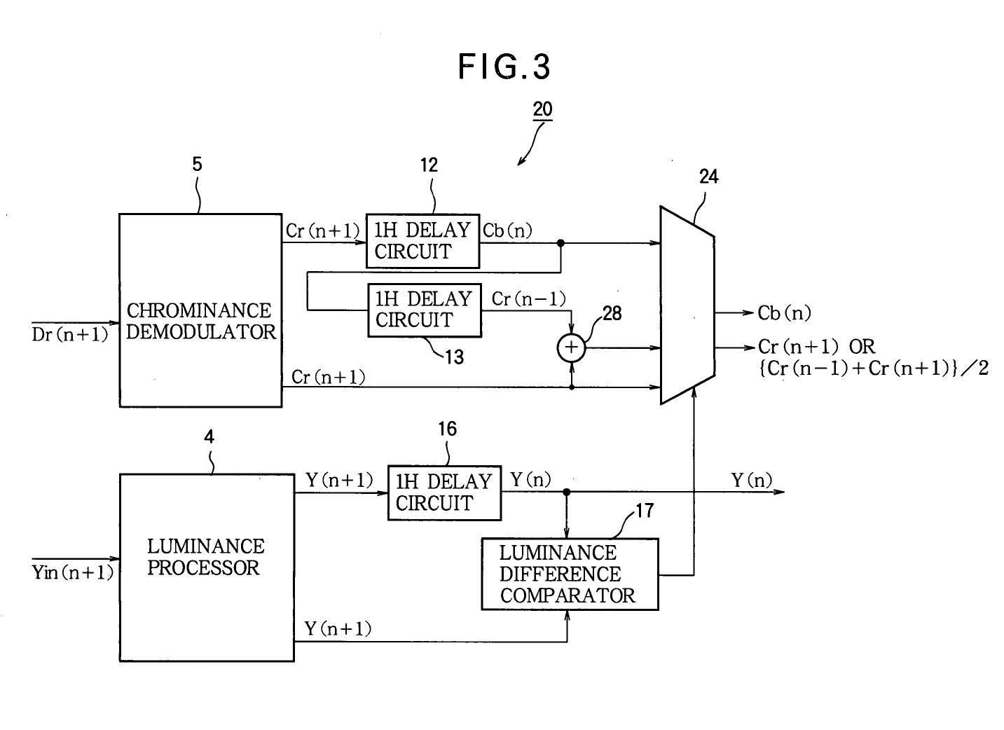

FIG. 3 shows a SECAM signal data processing circuit 20 that includes the luminance processor 4, the chrominance demodulator 5, and part of the data formatter 6 in FIG. 1 in a second embodiment of the invention. The part of this data processing circuit 20 disposed in the data formatter 6 in FIG. 1 includes the 1H delay circuits 12, 13, 16 and luminance difference comparator 17 described in the first embodiment, a different selector 24, and an averager 28.

The averager 28 adds the outputs of the chrominance demodulator 5 and 1H delay circuit 13 and right-shifts the resulting sum by one bit to obtain a color difference signal representing the average of the color difference signal in the input line and the color difference signal two lines before. In the example shown, these two signals are red color difference signals Cr(n+1) and Cr(n−1) and their average is {Cr(n+1)+Cr(n−1)}/2. When the control signal received from the luminance difference comparator 17 indicates that the difference between the luminance values in lines n and (n−1) was greater than the threshold (Th), the selector 24 selects the output of the chrominance demodulator 5 and the output of the 1H delay circuit 12, e.g., Cr(n+1) and Cb(n), as in the first embodiment. When the control signal indicates that the difference between the luminance values in lines n and (n−1) was less than the threshold (Th), the selector 24 selects the output of the averager 28 and the output of the 1H delay circuit 12, e.g., {Cr(n+1)+Cr(n−1)}/2 and Cb(n). The selection operation in the second embodiment can be summarized as follows.
If |Y(n)−Y(n−1)|<Th, then select C(n) and {C(n−1)+C(n+1)}/2
If |Y(n)−Y(n−1)|>Th, then select C(n) and C(n+1)

The output of the data processing circuit 20 includes the selected color difference signals and the corresponding luminance signal Y(n) for line n.

### Conventional Color Processing

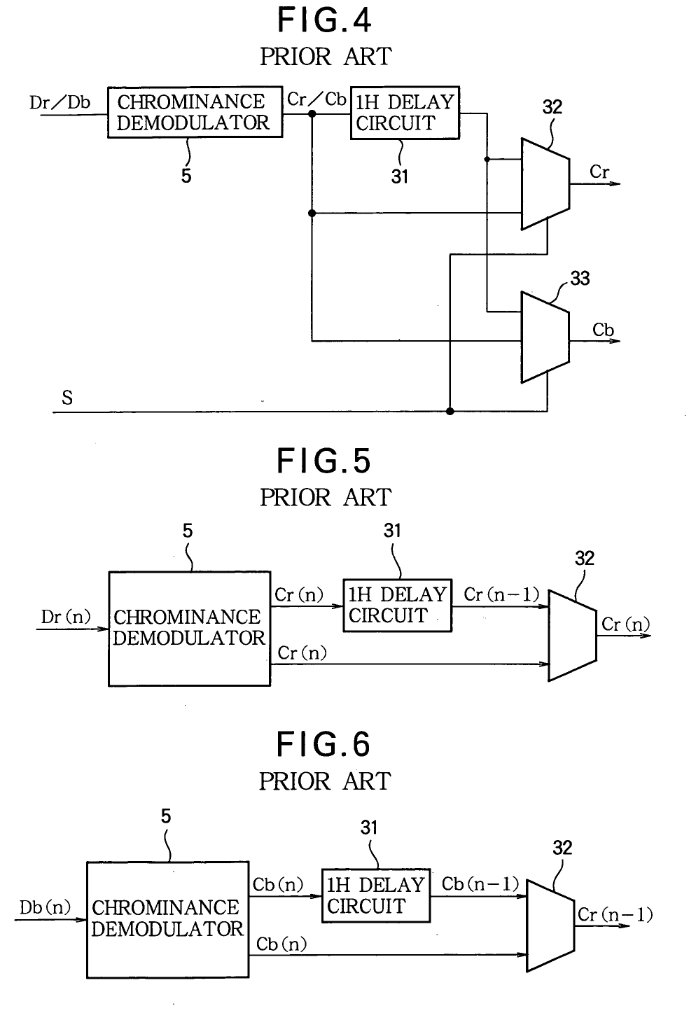

For comparison, FIG. 4 shows a conventional processing circuit comprising a chrominance demodulator 5 as in the preceding embodiments, a single 1H delay circuit 31, and a pair of selectors 32., 33 controlled by a data selection signal S generated from the horizontal synchronizing information. Selector 32 selects red color difference data Cr; selector 33 selects blue color difference data Cb. Accordingly, when the data selection signal S has one value, selector 32 selects the output of the chrominance demodulator 5 and selector 33 selects the output of the 1H delay circuit 31; when the data selection signal S has another value, selector 32 selects the output of the 1H delay circuit 31 and selector 33 selects the output of the chrominance demodulator 5. The data selection signal S switches between these two values in alternate lines.

FIG. 5 illustrates the operation of the chrominance demodulator 5 and selector 32 when the input line is line n and color difference signal is the red color difference signal Dr(n). The chrominance demodulator 5 outputs red color difference data Cr(n) while the 1H delay circuit 13 outputs the blue color difference data Cb(n−1) for the preceding line. Selector 32 selects the output of the chrominance demodulator 5 and outputs the red color difference signal Cr(n) for the current line.

FIG. 6 illustrates the operation of the chrominance demodulator 5 and selector 32 when the current line is line n and color difference signal is the blue color difference signal Db(n). The chrominance demodulator 5 outputs blue color difference data Cb(n) while the 1H delay circuit 13 outputs the red color difference data Cr(n−1) for the preceding line. Selector 32 selects the output of the 1H delay circuit 13 and outputs the red color difference signal Cr(n−1) from the preceding line.

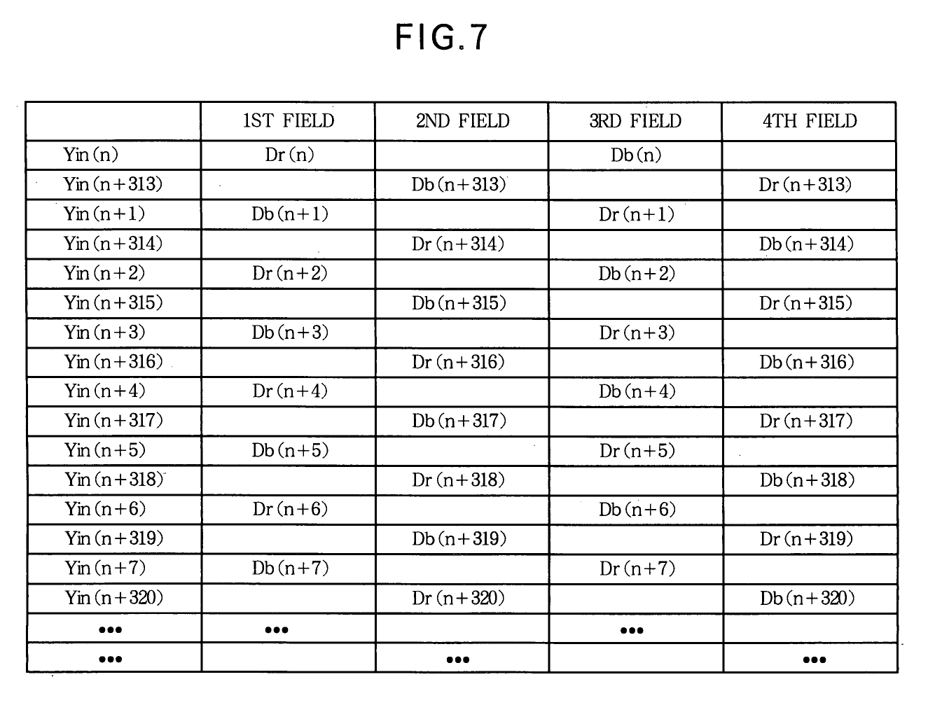

Next, the operation of the conventional color processing circuit and the above embodiments of the present invention will be described with reference to FIGS. 7 to 11.

FIG. 7 maps out the SECAM signal format over sixteen consecutive lines in four consecutive fields, constituting two consecutive frames. Lines n to (n+7) are interlaced with lines (n+313) to lines (n+320): for example, line (n+313) is physically located between lines n and (n+1) on the screen (n is an arbitrary integer from 1 to 304). Lines n to (n+7) are scanned in the first and third fields; lines (n+313) to (n+320) are scanned in the second and fourth fields. In line n, the luminance signal Yin(n) and the red color difference signal Dr(n) are received simultaneously in the first field, while the luminance signal Yin(n) and the blue color difference signal Dr(n) are received simultaneously in the third field. Conversely, in line (n+1) the luminance signal Yin(n+1) and blue color difference signal Db(n+1) are received simultaneously in the first field, while the luminance signal Yin(n+1) and red color difference signal Dr(n+1) are received simultaneously in the third field. Analogous relationships obtain in other lines and in the even-numbered fields.

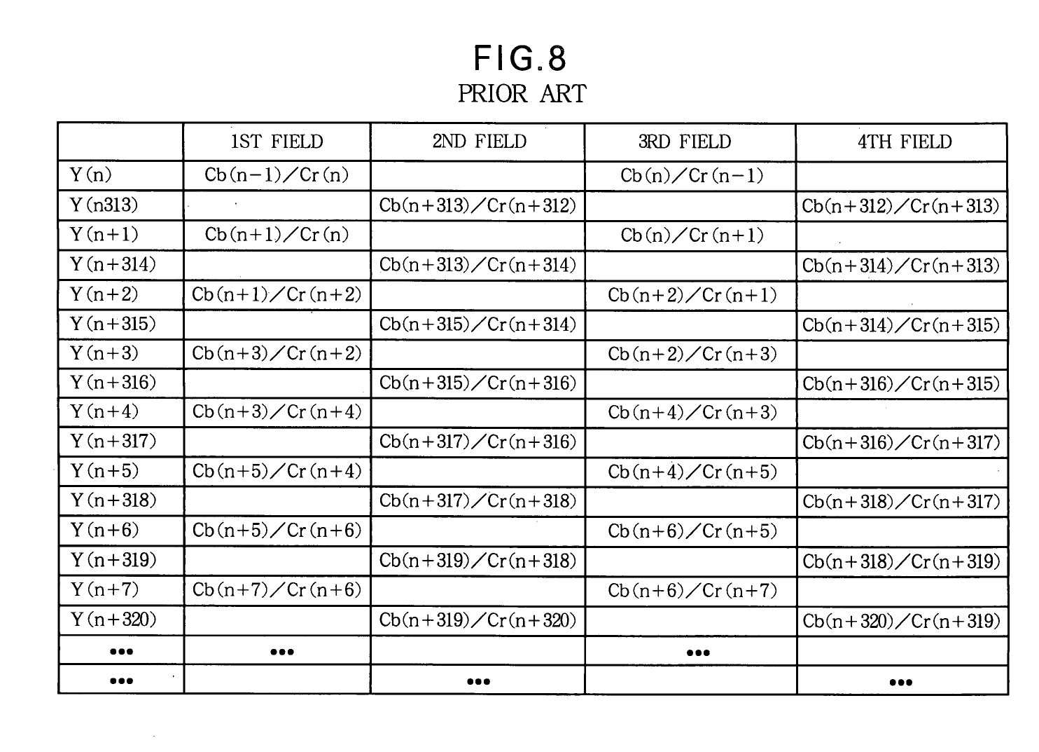

FIG. 8 illustrates the result of conventional processing of the signal data shown in FIG. 7. The notation Cb(n−1)/Cr(n) indicates that the color data selected for line n in the first field include the red color difference data Cr(n) from line n and the blue color difference data Cb(n−1) from the preceding line (n−1). Similar notation is used in the other lines and fields.

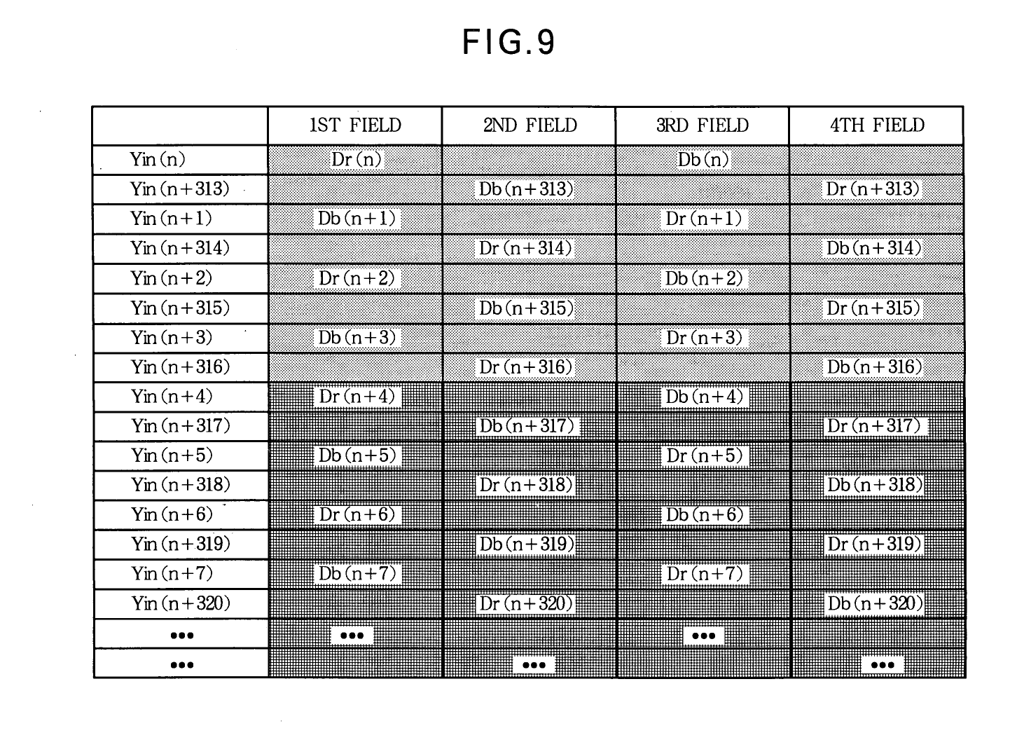

FIG. 9 shows the same SECAM signal map as FIG. 7 with additional shading to indicate that the upper part of the image, up to the line (n+3) in the first and third fields and line (n+316) in the second and fourth fields, is blue, and the lower part of the image, starting in line (n+4) in the first and third fields and line (n+317) in the second and fourth fields, is red. In the upper part of the image, the blue color difference data accordingly indicate a strong blue component while the red color difference data indicate a weak or absent red component. In the lower part of the image, the red color difference data indicate a strong red component while the blue color difference data indicate a weak or absent blue component.

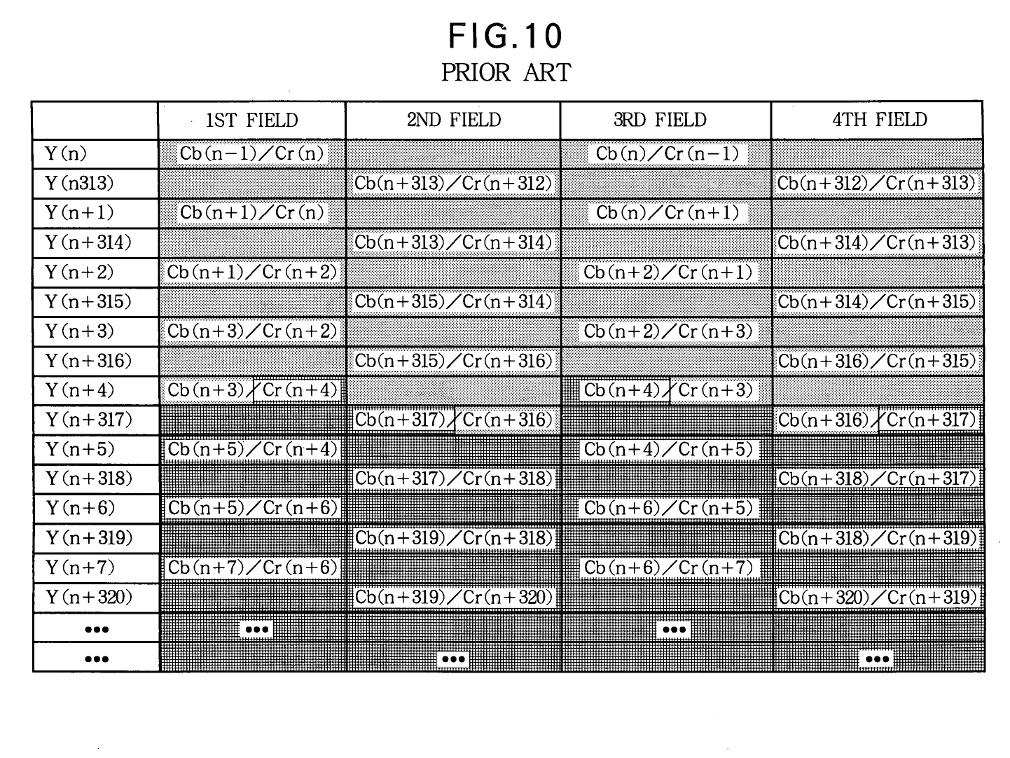

FIG. 10 illustrates the result of conventional processing of the image in FIG. 9. In the first field, the color information output for line (n+4) combines the strong blue data signal Cb(n+3) from the preceding line with the strong red data signal Cr(n+4) from line (n+4) itself, producing a strong purple color. In the second field, line (n+4) is not scanned. In the third field, the color information output for line (n+4) combines the weak or absent red data signal Cr(n+3) from the preceding line with the weak or absent blue data signal Cb(n+4) from line (n+4), and therefore has little or no coloration.

This pattern continues in subsequent fields, causing line (n+4) to flicker between strong and pale purple, or strong purple and a shade of gray. The flicker rate is one cycle every four fields, or approximately six cycles per second, which is slow enough to be irritatingly visible.

A similar purple flicker is visible at the same rate in line (n+317). In the second field, a weak or absent blue data signal Cb(n+317) is combined with a weak or absent red data signal Cr(n+316). In the fourth field, a strong blue data signal Cb(n+316) is combined with a strong red data signal Cr(n+317).

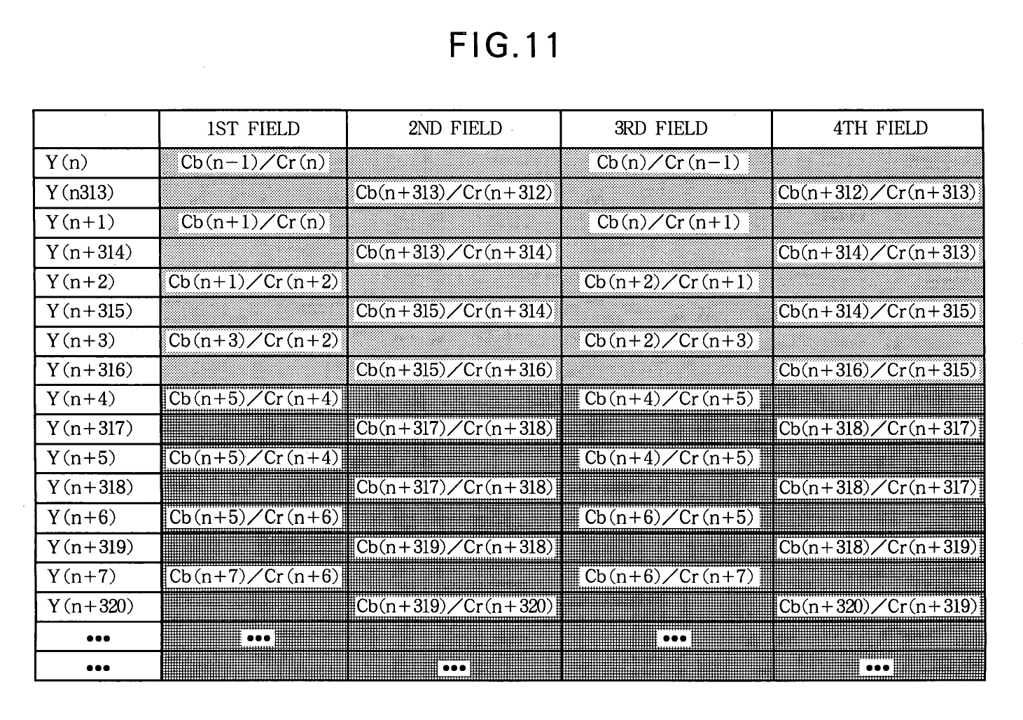

FIG. 11 illustrates the result of processing of the image in FIG. 9 by the data processing circuit 10 in the first embodiment. The abrupt shift from a blue image in line (n+316) and the lines above to a red image in line (n+4) and the lines below is accompanied by a substantial change in brightness, which is detected by the luminance difference comparator 17. More specifically, in the first and third fields, the luminance difference comparator 17 detects that the luminance difference between lines (n+4) and (n+3) exceeds the threshold Th, and selects the color difference data from lines (n+4) and (n+5) instead of lines (n+4) and (n+3). In the first field, the selector 14 selects the strong red data signal Cr(n+4) from line (n+4) and the weak blue data signal Cb(n+5) from line (n+5). In the third field, the selector 14 selects the strong red data signal Cr(n+5) from line (n+5) and the weak blue data signal from line (n+4). In both, fields, accordingly, line (n+4) looks unflickeringly red.

Similarly, in the second and fourth fields, the luminance difference comparator 17 detects an above-threshold luminance difference between lines (n+317) and (n+316) and selects the color difference data from lines (n+317) and (n+318), instead of from lines (n+317) and (n+316). In the second field, the selector 14 selects the strong red data signal Cr(n+317) from line (n+317) and the weak blue data signal Cb(n+318) from line (n+318). In the fourth field, the selector 14 selects the strong red data signal Cr(n+318) from line (n+318) and the weak blue data signal Cb(n+317) from line (n+317). In both fields, accordingly, line (n+317) also looks unflickeringly red.

In this example, the first embodiment produces a display in which lines (n+3) and (n+316) are consistently blue, while lines (n+4) and (n+317) are consistently red, as desired.

The second embodiment operates in much the same way as the first embodiment, removing flicker by substituting color difference data from the following line for color difference data from the preceding line when the luminance difference comparator 17 detects a large luminance difference between the current line and the preceding line. When the luminance difference comparator 17 detects a small luminance difference between the current and preceding line, however, the color information output for the current line includes the color difference data obtained from the current line and the average of the color difference values obtained from the preceding and following lines. That is, the selector 24 and averager 28 supply the color difference data missing in the current line by interpolating an average of the color difference data in the preceding and following lines, instead of simply using the data from the preceding line. This creates a more stable display by smoothing out certain forms of high-frequency spatial color noise and reducing the abruptness of spatial transitions in hue.

For example, the second embodiment alters the data processing illustrated in FIG. 11 by interpolating part of the red data from lines (n+4) and (n+317) into the blue boundary lines (n+3) and (n+316), creating a smoother blue-to-red transition from the upper part to the lower part of the image. These lines also acquire some flicker, since red data are interpolated only (or mainly) in the first and fourth fields, and the blue intensity is weakened in the second and third fields, but the resulting flicker is only about half as great as the conventional flicker that occurs in lines (n+4) and (n+317) in FIG. 10.

The second embodiment accordingly produces a balanced compromise between spatial and temporal smoothness. For reference, from the input data in FIG. 9, the second embodiment outputs the following color difference data in lines (n+3), (n+316), (n+4), and (n+317):

Line (n+3)

Cb(n+3) and {Cr(n+2)+Cr(n+4)}/2 in field 1

{Cb(n+2)+Cb(n+4)}/2 and Cr(n+3) in field 3

Line (n+316)

{Cb(n+315)+Cb(n+317)}/2 and Cr(n+316) in field 2

Cb(n+316) and {Cr(n+315)+Cr(n+317)}/2 in field 4

Line (n+4)

Cb(n+5) and Cr(n+4) in field 1

Cb(n+4) and Cr(n+5) in field 3

Line (n+317)

Cb(n+317) and Cr(n+318) in field 2

Cb(n+318) and Cr(n+317) in field 4

Lines (n+3) and (n+316) show a weakly flickering mixture of blue and red, with blue predominating, while lines (n+4) and (n+317) are consistently red.

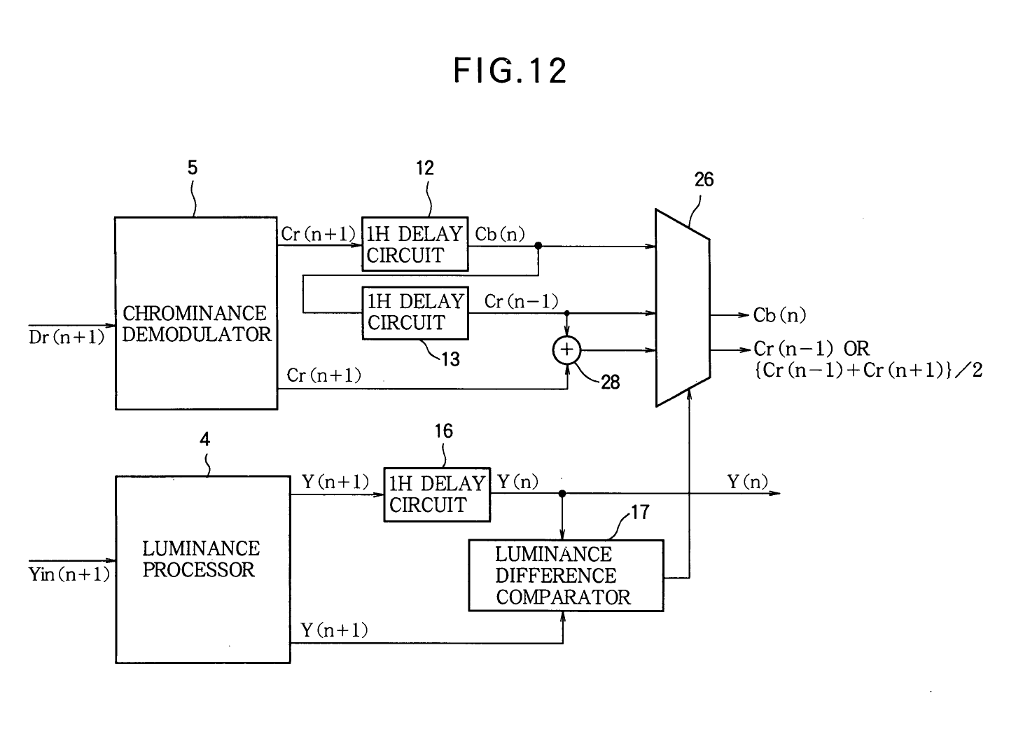

In a variation of the second embodiment, illustrated in FIG. 12, the average value of the color difference data in the preceding and following lines is used when the luminance difference between the current line and the preceding line is greater than, instead of less than, the threshold. When the difference is less than the threshold, the color data from the preceding line are used. The selector 26 accordingly receives the output of 1H delay circuit 13 instead of the output of the chrominance demodulator 5. The selection operation in this variation can be summarized as follows:
If |Y(n)−Y(n−1)|<Th, then select C(n) and C(n−1)
If |Y(n)−Y(n−1)|>Th, then select C(n) and {C(n−1)+C(n+1)}/2

For reference, from the input data in FIG. 9, this variation of the second embodiment outputs the following color difference data in lines (n+3), (n+316), (n+4), and (n+317):

Line (n+3)

Cb(n+3) and Cr(n+2) in field 1

Cb(n+2) and Cr(n+3) in field 3

Line (n+316)

Cb(n+315) and Cr(n+316) in field 2

Cb(n+316) and Cr(n+315) in field 4

Line (n+4)

{Cb(n+3)+Cb(n+5)}/2 and Cr(n+4) in field 1

Cb(n+4) and {Cr(n+3)+Cr(n+5)}/2 in field 3

Line (n+317)

Cb(n+317) and {Cr(n+316)+Cr(n+318)}/2 in field 2

{Cb(n+316)+Cb(n+318)}/2 and Cr(n+317) in field 4

Lines (n+3) and (n+316) are accordingly consistently blue, while lines (n+4) and (n+317) show a weakly flickering mixture of blue and red, with red predominating.

This variation produces much the same effect as the second embodiment itself, while maintaining the conventional SECAM color resolution in the absence of large line-to-line luminance differences.

The first and second embodiments can also be varied by selecting different combinations of color difference data according to the luminance difference between the current line and the next line. One such variation, based on the first embodiment, operates as follows:
If |Y(n+1)−Y(n)|<Th, then select C(n) and C(n+1)
If |Y(n+1)−Y(n)|>Th, then select C(n) and C(n−1)

Another such variation, based on the second embodiment, operates as follows:
If |Y(n+1)−Y(n)|<Th, then select C(n) and {C(n−1)+C(n+1)}/2
If |Y(n+1)−Y(n)|>Th, then select C(n) and C(n−1)

Still another such variation, also based on the second embodiment, operates as follows:
If |Y(n+1)−Y(n)|<Th, then select C(n) and C(n+1)
If |Y(n+1)−Y(n)|>Th, then select C(n) and {C(n−1)+C(n+1)}/2

Those skilled in the art will recognize that further variations are possible within the scope of the invention, which is defined in the appended claims.

What is claimed is:

1. A method of processing a SECAM color difference signal, comprising:
processing a SECAM video signal to obtain a first luminance signal and a first chrominance signal;
delaying the first luminance signal by one horizontal interval to obtain a second luminance signal;
delaying the first chrominance signal by one horizontal interval to obtain a second chrominance signal;
delaying the second chrominance signal by one horizontal interval to obtain a third chrominance signal;
calculating a difference between the first luminance signal and the second luminance signal; and
selecting different combinations of the first, second, and third chrominance signals according to the difference.

2. The method of claim 1, wherein the difference calculated in one horizontal interval controls the selecting of different combinations of the first, second, and third chrominance signals in a following horizontal interval.

3. The method of claim 2, wherein the selected combinations include:
a first combination consisting of the first chrominance signal and the second chrominance signal; and
a second combination consisting of the second chrominance signal and the third chrominance signal.

4. The method of claim 3, further comprising comparing the difference with a threshold, wherein the first combination is selected when the difference is greater than the threshold and the second combination is selected when the difference is less than the threshold.

5. The method of claim 2, further comprising calculating an average value of the first and third chrominance signals, wherein the selected combinations include:
a first combination consisting of the first chrominance signal and the second chrominance signal; and
a second combination consisting of the second chrominance signal and the average value.

6. The method of claim 5, further comprising comparing the difference with a threshold, wherein the first combination is selected when the difference is greater than the threshold and the second combination is selected when the difference is less than the threshold.

7. The method of claim 2, further comprising calculating an average value of the first and third chrominance signals, wherein the selected combinations include:
a first combination consisting of the second chrominance signal and the third chrominance signal; and
a second combination consisting of the second chrominance signal and the average value.

8. The method of claim 7, further comprising comparing the difference with a threshold, wherein the first combination is selected when the difference is less than the threshold and the second combination is selected when the difference is greater than the threshold.

9. The method of claim 1, wherein the difference calculated in one horizontal interval controls the selecting of different combinations of the first, second, and third chrominance signals in said horizontal interval.

10. The method of claim 9, wherein the selected combinations include:
a first combination consisting of the first chrominance signal and the second chrominance signal; and
a second combination consisting of the second chrominance signal and the third chrominance signal.

11. The method of claim 10, further comprising comparing the difference with a threshold, wherein the first combination is selected when the difference is less than the threshold and the second combination is selected when the difference is greater than the threshold.

12. The method of claim 9, further comprising calculating an average value of the first and third chrominance signals, wherein the selected combinations include:
a first combination consisting of the second chrominance signal and the third chrominance signal; and
a second combination consisting of the second chrominance signal and the average value.

13. The method of claim 12, further comprising comparing the difference with a threshold, wherein the first combination is selected when the difference is greater than the threshold and the second combination is selected when the difference is less than the threshold.

14. The method of claim 9, further comprising calculating an average value of the first and third chrominance signals, wherein the selected combinations include:
a first combination consisting of the first chrominance signal and the second chrominance signal; and
a second combination consisting of the second chrominance signal and the average value.

15. The method of claim 14, further comprising comparing the difference with a threshold, wherein the first combination is selected when the difference is less than the threshold and the second combination is selected when the difference is greater than the threshold.

16. A decoder for decoding a SECAM video signal including a luminance signal and a chrominance signal, the decoder comprising:
a first delay circuit for delaying the chrominance signal by one horizontal interval to obtain a first delayed chrominance signal;
a second delay circuit for delaying the first delayed chrominance signal by one horizontal interval to obtain a second delayed chrominance signal;
a third delay circuit for delaying the luminance signal by one horizontal interval to obtain a delayed luminance signal;
a luminance difference comparator for taking a difference between the luminance signal and the delayed luminance signal and generating a control signal from the difference; and
a selector for selecting different combinations of the chrominance signal, the first delayed chrominance signal, and the second delayed chrominance signal according to the control signal.

17. The decoder of claim 16, wherein the luminance difference comparator generates the control signal by comparing the difference with a threshold.

18. The decoder of claim 16, wherein the different combinations include:
a first combination consisting of the chrominance signal and the first delayed chrominance signal; and
a second combination consisting of the first delayed chrominance signal and the second delayed chrominance signal.

19. The decoder of claim 16, further comprising an adder for taking an average value of the chrominance signal and the second delayed chrominance signal, wherein the different combinations include:
a first combination consisting of the chrominance signal and the first delayed chrominance signal; and
a second combination consisting of the first delayed chrominance signal and the average value.

20. The decoder of claim 16, further comprising an adder for taking an average value of the chrominance signal and the second delayed chrominance signal, wherein the combinations include:
a first combination consisting of the first delayed chrominance signal and the second delayed chrominance signal; and
a second combination consisting of the first delayed chrominance signal and the average value.
